(19) United States
(12) Patent Application Publication
(10) Pub. No.: US 2020/0165374 A1
(43) Pub. Date: May 28, 2020

(54) PROCESS FOR PRODUCING LOW-VISCOSITY NCO-CONTAINING PREPOLYMERS HAVING A LOW RESIDUAL MONOMER CONTENT

(71) Applicant: Evonik Operations GmbH, Essen (DE)

(72) Inventors: Emmanouil Spyrou, Schermbeck (DE); Holger Loesch, Herne (DE); Susanne Kreischer, Herten (DE); Andrea Diesveld, Gescher (DE)

(73) Assignee: Evonik Operations GmbH, Essen (DE)

(21) Appl. No.: 16/684,942

(22) Filed: Nov. 15, 2019

(30) Foreign Application Priority Data
Nov. 23, 2018 (EP) 18207956.6

(51) Int. Cl. C08G 18/10; C08G 18/75; C08G 18/73; C08G 18/42

(52) U.S. Cl. CPC C08G 18/10; C08G 18/757; C08G 18/42; C08G 18/73; C08G 18/755

(57) ABSTRACT

The present invention relates to a process for producing NCO-containing prepolymers, to the prepolymers producible by the process and to the use of the prepolymers.

This application is a 35 U.S.C. § 119 patent application which claims the benefit of European Application No. 18207956.6 filed Nov. 23, 2018, which is incorporated herein by reference in its entirety.

### FIELD

Polyurethanes and polyureas are valuable raw materials for the paint, adhesive, sealant and plastics industries. One route to these is via NCO-containing prepolymers. These may be obtained via the reaction of polyols with diisocyanates, such as for example disclosed in EP 0 669 353 A1, EP 0 669 354 A1, DE 30 30 572 A1, EP 0 639 598 A1 and EP 0 803 524 A1 for uretdione group-containing diisocyanates.

### BACKGROUND

WO 2009/059848 A1 discloses NCO-containing prepolymers prepared from dicyclohexylmethane diisocyanate (H12MDI), IPDI and at least one polyether polyol. However, the NCO-containing prepolymers disclosed therein have the disadvantage that the underlying polyethers, as is well known, have a tendency to oxidative degradation, and are therefore not UV stable in particular. They decompose and discolor under solar irradiation.

In the production of the NCO-containing prepolymers, the isocyanates are typically used in stoichiometric excess. A disadvantage, however, is the proportion of unreacted diisocyanate (residual monomer content), which can result in toxicological problems. Particularly critical here are the unreacted volatile diisocyanates. There has not been a lack of attempts to lower their proportion in order to minimize toxicological problems. One possibility is to keep the stoichiometric excess of diisocyanates as low as possible. However, this results in higher viscosities which render the use of such products difficult. Another possibility consists in a subsequent distillation in order to remove this residual monomer content by distillation.

However, this requires a further process step and additional energy, and the product is subjected to a not inconsiderable thermal stress.

U.S. Pat. No. 3,904,796 A discloses NCO-containing prepolymers prepared from aliphatic or cycloaliphatic isocyanates and polyhydroxy compounds. The examples disclose inter alia prepolymers composed of IPDI or a mixture of IPDI and bis(isocyanatomethylcyclohexyl)methane and also a hydroxy-functional polyester. The prepolymers mentioned are synthesized by addition of the isocyanates to the initially charged polyesters.

EP 0 452 775 A2 discloses NCO-containing prepolymers prepared from hydroxy-functional polyesters and a mixture of IPDI and bis(isocyanatomethylcyclohexyl)methane. Here too, the isocyanates are added to the initially charged hydroxy-functional polyesters.

### SUMMARY

The problem addressed by the present invention was that of making available NCO-containing prepolymers having low viscosity and low residual monomer content of volatile diisocyanates. It has surprisingly been found that when synthesizing the prepolymers the order of the individual components has a decisive influence: if the isocyanates (and not the polyester polyols) are initially charged and the polyester polyols (and not the isocyanates) are added thereto, this results in NCO-containing prepolymers having a lower viscosity and a lower residual monomer content of more volatile diisocyanates.

### DETAILED DESCRIPTION

The present invention thus provides a process for producing an NCO-containing prepolymer in which
a. bis(isocyanatomethylcyclohexyl)methane and
b. at least one diisocyanate that is more volatile are initially charged and
c. at least one polyester polyol
d. and optionally further auxiliaries are added.

To achieve particularly good results, the at least one polyester polyol is added in portions.

The component a), bis(isocyanatomethylcyclohexyl)methane (H12MDI), used may in principle be all isomers, specifically dicyclohexylmethane 2,2′-, 2,4′- and/or 4,4′-diisocyanate. Preferably, the bis(isocyanatomethylcyclohexyl)methane (H12MDI) comprises at least 80% by weight of the 4,4′ isomer, preferably 85%-95% by weight, and 5% to 20% by weight, preferably 7%-15% by weight, of the 2,4′ isomer. The bis(isocyanatomethylcyclohexyl)methane (H12MDI) furthermore preferably contains a low proportion of 2,2′-H12MDI of less than 5% by weight, preferably less than 1% by weight. The trans,trans content of 4,4′-H12MDI is preferably less than 30%, preferably from 5% to 25%.

In addition to H12MDI, during the production of the prepolymers at least one further diisocyanate which is more volatile compared to H12MDI is used.

Suitable more volatile diisocyanates are all aliphatic and cycloaliphatic and araliphatic diisocyanates having a lower boiling point than H12MDI (b.p.: 413° C. at standard pressure—1013 mbar, optionally converted using Advanced Chem. Develop. Software V11.02 from 2016 (https://www. sigmaaldrich.com/chemistry/solvents/learning-center/nomograph. html) according to the literature data of Siefken, Werner; Annalen der Chemie, Justus Liebigs 1949, V562, P75-136; boiling point of H12MDI: 156-158° C. at 0.1 ton).

Preference is given to cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate (preferably pentamethylene diisocyanate), hexane diisocyanate (preferably hexamethylene diisocyanate (HDI) and 1,5-diisocyanato-2-methylpentane (MPDI)), heptane diisocyanate, octane diisocyanate, nonane diisocyanate (preferably a mixture of 1,6-diisocyanato-2,4,4-trimethylhexane and 1,6-diisocyanato-2,2,4-trimethylhexane (TMDI)), nonane triisocyanate (preferably 4-isocyanatomethyl-1,8-octane diisocyanate (TIN)), decane di- and triisocyanate, undecane di- and triisocyanate, dodecane di- and triisocyanate, isophorone diisocyanate (IPDI), isocyanatomethylmethylcyclohexyl isocyanate, 2,5(2,6)-bis(isocyanatomethyl)bicyclo[2.2.1]heptane (NBDI), 1,3-bis(isocyanatomethyl)cyclohexane (1,3-H₆-XDI) and also 1,4-bis(isocyanatomethyl)cyclohexane (1,4-H₆-XDI), tetramethylxylylene diisocyanate (TMXDI) and lysine diisocyanate alkyl ester.

Further preference is given to isophorone diisocyanate, pentamethylene diisocyanate, hexamethylene diisocyanate and trimethylhexamethylene diisocyanate, the latter preferably a mixture of 1,6-diisocyanato-2,4,4-trimethylhexane and 1,6-diisocyanato-2,2,4-trimethylhexane. The component b) used is more preferably a mixture of at least two of the four diisocyanates mentioned.

The isocyanates b) are more volatile compared to H12MDI. In principle, these isocyanates can be prepared by different methods. A particularly useful method in industry has been found to be the preparation by phosgenation of organic polyamines to give the corresponding polycarbamoyl chlorides and the thermal cleavage thereof to organic polyisocyanates and hydrogen chloride. Alternatively, organic polyisocyanates can also be prepared without use of phosgene, that is to say by phosgene-free methods. (Cyclo)aliphatic diisocyanates such as 1-isocyanato-3-isocyanatomethyl-3,5,5-trimethylcyclohexane (isophorone diisocyanate or IPDI) can be made available by reacting the parent (cyclo)aliphatic diamines with urea and alcohols to give (cyclo)aliphatic biscarbamoyl esters and thermal cleavage thereof to the corresponding diisocyanates and alcohols.

The mass ratio between H12MDI and the more volatile diisocyanate component(s) is preferably between 90:10 and 10:90, based on the proportion by weight of the two components a) and b). An excess of H12MDI is preferably used, that is to say the ratio is greater than 55:45, more preferably greater than 65:35, even more preferably greater than 75:25.

The component c) used is at least one, at least difunctional, hydroxyl group-containing polyester polyol. The polyester polyol preferably has an OH number of 10 to 2000 (in mg KOH/gram). Particular preference is given to hydroxyl group-containing polyesters having an OH number of 20 to 150 and a number-average molecular weight of 500 to 6000 g/mol.

Preferred auxiliaries d) are especially non-protic solvents and catalysts known in polyurethane chemistry for the NCO—OH reaction (especially organometallic compounds such as dibutyltin dilaurate=DBTL or tertiary amines such as diazabicyclooctane and triethylamine).

This reaction may take place with or without solvent. Preferably, no solvent is used.

Furthermore, the reaction is preferably carried out between 40 and 80° C. and in the presence of a catalyst.

Suitable reaction units include all customary apparatuses, tanks, static mixers, extruders, etc., preferably units which possess a mixing or stirring function.

The NCO/OH ratio is preferably from 10:1 to 1.2:1, more preferably 5:1 to 1.6:1, particularly preferably 3:1 to 1.8:1.

The process according to the invention is preferably carried out such that the reaction product preferably has a residual monomer content of the more volatile diisocyanate component of at most 6.2%, preferably <2.5% and particularly preferably <0.5%, determined by GC. In addition, the proportion of residual monomer H12MDI is preferably less than 33%, preferably <6.6%. The viscosity can be controlled via the polyol used and the NCO:OH ratio. The process is preferably carried out such that the viscosity of the resulting product is less than when using pure H12MDI at the same NCO ratio.

The present invention additionally provides the NCO-containing prepolymer obtainable by the process according to the invention. As already stated, this differs from the prepolymers known in the prior art with respect to viscosity and residual monomer content.

The present invention moreover provides for the use of the prepolymers according to the invention and/or of the products producible by the process according to the invention as a constituent of paint, adhesive, sealant or plastics formulations.

### EXAMPLES

### Example 1, Inventive

A mixture of 80 g of VESTANAT H12MDI (b.p.: 413° C. at 1013 mbar, calculated as stated above, Evonik Industries AG) and 20 g of VESTANAT IPDI (b.p.: 303.7° C., Evonik Industries AG) is heated to 40° C. in a stirred three-neck flask and admixed with 0.05 g of catalyst (dibutyltin dilaurate, DBTL). To this are added dropwise 207 g of Oxyester T1136 (polyester polyol, OH number 107 mg KOH/g, Evonik Industries) (NCO:OH=2:1). The temperature is also maintained at 40° C. for 4 h after the addition. The product has an NCO number of 5.3%, a residual monomer content of IPDI of 0.17%, a residual monomer content of H12MDI of 3.9% and a viscosity (23° C.) of 760 Pas.

### Example 2, Non-Inventive

100 g of VESTANAT H12MDI (b.p.: 413° C. at 1013 mbar, calculated as stated above, Evonik Industries AG) are heated to 40° C. in a stirred three-neck flask and admixed with 0.05 g of catalyst (dibutyltin dilaurate, DBTL). To this are added dropwise 200 g of Oxyester T1136 (polyester polyol, OH number 107 mg KOH/g, Evonik Industries) (NCO:OH=2:1). The temperature is also maintained at 40° C. for 4 h after the addition. The product has an NCO number of 5.1%, a residual monomer content of H12MDI of 4.0% and a viscosity (23° C.) of 3000 Pas.

### Example 3, Non-Inventive

100 g of VESTANAT IPDI (b.p.: 303.7° C., Evonik Industries AG) are heated to 40° C. in a stirred three-neck flask and admixed with 0.05 g of catalyst (dibutyltin dilaurate, DBTL). To this are added dropwise 236 g of Oxyester T1136 (polyester polyol, OH number 107 mg KOH/g, Evonik Industries) (NCO:OH=2:1). The temperature is also maintained at 40° C. for 4 h after the addition. The product has an NCO number of 5.1%, a residual monomer content of IPDI of 1.33%, and a viscosity (23° C.) of 820 Pas.

### Example 4, Non-Inventive

207 g of Oxyester T1136 (polyester polyol, OH number 107 mg KOH/g, Evonik Industries) are heated to 40° C. in a stirred three-neck flask and admixed with 0.05 g of catalyst (dibutyltin dilaurate, DBTL). To this is added dropwise a mixture of 80 g of VESTANAT H12MDI (b.p.: 413° C. at 1013 mbar, calculated as stated above, Evonik Industries AG) and 20 g of VESTANAT IPDI (b.p.: 303.7° C., Evonik Industries AG) (NCO:OH=2:1). The temperature is also maintained at 40° C. for 4 h after the addition. The product has an NCO number of 5.1%, a residual monomer content of IPDI of 1.1%, a residual monomer content of H12MDI of 5.2% and a viscosity (23° C.) of 870 Pas.

### Example 5, Non-Inventive

207 g of Oxyester T1136 (polyester polyol, OH number 107 mg KOH/g, Evonik Industries) and a mixture of 80 g of VESTANAT H12MDI (b.p.: 413° C. at 1013 mbar, calculated as stated above, Evonik Industries AG) and 20 g of VESTANAT IPDI (b.p.: 303.7° C., Evonik Industries AG) (NCO:OH=2:1) and 0.05 g of catalyst (dibutyltin dilaurate, DBTL) are mixed in a three-neck flask and heated to 40° C. The temperature is maintained at 40° C. for 4 h. The product has an NCO number of 5.0%, a residual monomer content of IPDI of 0.5%, a residual monomer content of H12MDI of 5.5% and a viscosity (23° C.) of 790 Pas.

| | IPDI | H12MDI | |
|---|---|---|---|
| | Residual | Residual | Viscosity |
| | Monomer (%) | Monomer (%) | (Pas) |
| Example 1 | 0.17 | 3.9 | 760 |
| Example 2* | 0 | 4.0 | 3000 |
| Example 3* | 1.33 | 0 | 820 |
| Example 4* | 1.1 | 5.2 | 870 |
| Example 5* | 0.5 | 5.5 | 790 |

*not according to the invention

Only the example according to the invention has both a low residual monomer content of IPDI and a low viscosity.

1. A process for producing an NCO-containing prepolymer, wherein
a. bis(isocyanatomethylcyclohexyl)methane and
b. a diisocyanate that is more volatile are initially charged and
c. a polyester polyol
d. and optionally further auxiliaries are added.

2. The process according to claim 1, wherein the at least one polyester polyol is added in portions.

3. The process according to claim 1, wherein the bis(isocyanatomethylcyclohexyl)methane comprises at least 80% by weight of the 4,4′ isomer and from 5 to 20% by weight of the 2,4′ isomer.

4. The process according to claim 1, wherein the diisocyanate is selected from the group consisting of cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, decane di- and triisocyanate, undecane di- and triisocyanate, dodecane di- and triisocyanate, isophorone diisocyanate, isocyanatomethylmethylcyclohexyl isocyanate, 2,5(2,6)-bis(isocyanatomethyl)bicyclo[2.2.1]heptane, 1,3-bis(isocyanatomethyl)cyclohexane and also 1,4-bis(isocyanatomethyl)cyclohexane, tetramethylxylylene diisocyanate and lysine diisocyanate alkyl ester.

5. The process according to claim 1, wherein the diisocyanate is isophorone diisocyanate, pentamethylene diisocyanate, hexamethylene diisocyanate and/or trimethylhexamethylene diisocyanate.

6. The process according to claim 1, wherein the mass ratio between bis(isocyanatomethylcyclohexyl)methane and the more volatile diisocyanate component(s) is between 90:10 and 10:90.

7. The process according to claim 1, wherein the at least one polyester polyol has an OH number of from 20 to 150 and a number-average molecular weight of from 500 to 6000 g/mol.

8. The process according to claim 1, wherein said process is carried out free of solvent.

9. The process according to claim 1, wherein said process is carried out at a temperature from 40 to 80° C. and in the presence of a catalyst.

10. The process according to claim 1, wherein the NCO/OH ratio is from 10:1 to 1.2:1.

11. The NCO-containing prepolymer obtainable by a process according to claim 1.

12. A constituent comprising the prepolymer according to claim 11.

13. A product selected from the group consisting of paint, adhesive, sealant or plastics formulations wherein the product comprises the constituent of claim 12.

14. The process according to claim 2, wherein the bis(isocyanatomethylcyclohexyl)methane comprises at least 80% by weight of the 4,4′ isomer and from 5 to 20% by weight of the 2,4′ isomer.

15. The process according to claim 3, wherein the diisocyanate is isophorone diisocyanate, pentamethylene diisocyanate, hexamethylene diisocyanate and/or trimethylhexamethylene diisocyanate.

16. The process according to claim 3, wherein the mass ratio between bis(isocyanatomethylcyclohexyl)methane and the more volatile diisocyanate component(s) is between 90:10 and 10:90.

17. The process according to claim 3, wherein the at least one polyester polyol has an OH number of from 20 to 150 and a number-average molecular weight of from 500 to 6000 g/mol.

18. The process according to claim 1, wherein said process is carried out free of solvent.

19. The process according to claim 3, wherein said process is carried out at a temperature from 40 to 80° C. and in the presence of a catalyst.

20. The process according to claim 1, wherein the NCO/OH ratio is from 10:1 to 1.2:1.
